(19) United States
(12) Patent Application Publication
(10) Pub. No.: US 2024/0022156 A1
(43) Pub. Date: Jan. 18, 2024

(54) ENERGY CAPTURE DEVICE

(71) Applicant: Richard A. Carmody, III, Ringgold, GA (US)

(72) Inventor: Richard A. Carmody, III, Ringgold, GA (US)

(21) Appl. No.: 18/221,508

(22) Filed: Jul. 13, 2023

Related U.S. Application Data
(60) Provisional application No. 63/389,411, filed on Jul. 15, 2022.

(51) Int. Cl. H02K 35/02; H02K 7/18

(52) U.S. Cl. CPC H02K 35/02; H02K 7/1807

(57) ABSTRACT

By stacking magnets in a pyramid shape, it is believed that magnetic field can be focused thereby increasing the performance of energy capture devices like generators, etc. These pyramid structures may be used with an oscillating embodiment or a rotating embodiment whereby relative motion of at least one set of magnets relative to at least one coil may generate electrical energy.

### CLAIM OF PRIORITY

The application claims the benefit of U.S. Provisional application No. 63/389,411 filed Jul. 15, 2022, which is incorporated herein by reference in its entirety.

### FIELD OF THE INVENTION

An energy capture device has a magnet moving relative to a coil to generate electricity in one of several embodiments such as an oscillating energy capture device, and more traditional axle supported devices.

### BACKGROUND OF THE INVENTION

Magnets moving relative to coils are known to generate electricity. However, there are believed to be improvements available over prior art designs.

### SUMMARY OF THE INVENTION

It is an object of many embodiments of the present invention to provide a device whereby at least one magnet moves relative to a coil or visa versa to generate electricity. Different devices may take on at least one of a variety of the improvements taught herein.

An oscillating embodiment may be provided such as a shake light, whereby a magnet is moved through an arcuate coil in an oscillating manner, aka, possibly by shaking to generate electricity as the magnet moves through the coil in a reciprocating path, with that path be arcuate as illustrated, as opposed to a linear path, as has been done in the prior art. Also, in prior art shake lights, if the linear distance of travel of the magnet is 9 inches, the coil is normally the middle three inches. For many preferred embodiments, the curved coil of the applicant's embodiment is substantially, if not the entire length of travel of the magnet.

Material selection may be relevant for many embodiments. Carbon fiber may be utilized to provide disc structure for receivers and/or tubes/magnet structure(s). A 1½-1¾ carbon fiber disc has been found effective for ⅛-⅜ or 3/16 to receive a tip of an exposed triangular coil therein. Additionally, copper tubes may be used. A semi=circle or other magnet shape may be suspended, at least in part, by magnetic flux other otherwise, possibly within the tubing. Aluminum tubes may also be used, possibly coated in graphene, possibly through chemical vapor deposition or other technique. Graphene could be as think as one molecule thick at the surface or have other dimensions. A combination of graphene with aluminum may prove to have greater conductivity value than copper.

For some embodiments, pyramid stacking of magnets may be useful to provide additional surface area as well as potentially focus magnetic fields in a specific direction to increase the efficiency of the electrical generation process. A reversed pyramid orientation may provide a similar effect. The tubes may be constructed to cooperate with the pyramid cross section of the magnets. Apex of triangle may be at the 12 o'clock position with the base at the 6 o'clock position. Alternatively, the apex could be at the 6 o'clock position while the base could be at the 12 o'clock position. Other variations or positions could be achieved with other embodiments.

Pyramid shaped magnet constructions could have a 4×4 inch base, possibly with a 1×1 inch top (or a relatively similar sizing). A gauss reading may be roughly 5,800 gauss or other value. When stacking incrementally with smaller and smaller magnets, the force of the magnets is believed to be focused, magnified, and/or amplified. The effect may be similar to that of how a convex lens concentrates light towards a fine point. The stacking technique may permit the magnetic force to travel upward, and/or inward, thereby increasing the gauss levels. When the magnetic force follows a preferred path of travel through metal, rather than air, the stacking technique may amplify the gauss readings to nearly 10,000 gauss or 1 Tesla.

In vehicle embodiments, employing one or more energy capture devices on the vehicle, either on axles or in a manner designed to capture energy from the relative wind generated by the vehicle, that energy may be captured and stored for use by electric motors to operate the vehicle and/or for other purposes. Smaller electric batteries may be utilized by the vehicle than otherwise might be required. Regenerative braking may be achieved with many embodiments. New alternators may be constructed using this technology, possibly driven by a motor shaft.

Concentric coils of magnets may be employed, sch as with separate magnets and possibly separate induction receivers, so that at least some of the components have positive and negative terminals transmitting electricity for storage, such as to a battery, and/or for use by motor or other electrical component.

In addition to use on vehicles, generators may employ the energy capture device of many preferred embodiments, such as wind turbines, air dams, water turbines, etc. At least one embodiment may provide a gravity induced environment where a magnet directs a piston upwardly away from the magnet to then fall by gravity back toward the magnet. The motion may be within a coil to be captured in the form of electrical energy.

A pyramid shaped stacking technique (or forming technique may be employed with a gravitational energy capture and conversion machine. The stacked magnet could be located at a six o'clock position. An amplified magnetic repulsion could provide thrust to an arm toward a 12 o'clock position through a coil and then gravity direct downwardly back toward the 6 o'clock position while the coil could capture the electrical energy from the kinetic energy of the motion of the arm.

Some embodiments capture waste energy, such as from wind passing beside, through or around a vehicle. An atomizer effect may pull some of the air to propel rotation of discs relative to magnets to generate electricity, such as within a portion of the vehicle (such as images of the vehicle show). Other embodiments may have tires that assist in imparting rotation to discs.

### BRIEF DESCRIPTION OF THE DRAWINGS

The particular features and advantages of the invention as well as other objects will become apparent from the following description taken in connection with the accompanying drawings in which:

FIG. 1 is a side plan view with internal portions shown in phantom of a first presently preferred embodiment of the invention;

FIG. 2 is a cross sectional view taken along the line A-A of FIG. 1;

FIG. 3 is a side plan view with internal portions shown in phantom of a second presently preferred embodiment of the present invention;

FIG. 4 is a cross sectional view taken along the line B-B of FIG. 3;

FIG. 5 is a cross sectional view of a third embodiment of the present invention;

FIG. 6 is side plan view with internal portions shown in phantom of a third presently preferred embodiment of the present invention;

FIG. 7 is a cross sectional view taken along the line C-C of FIG. 6;

FIG. 8 is a side plan view of detail D from FIG. 6;

FIG. 9 a front plan view of a vehicle having five separate devices, at least one of which being a fourth embodiment of the present invention, and possibly four being the third embodiment;

FIG. 10 is a cross sectional view taken along the line E-E of FIG. 9;

FIG. 11 is front plan view of a fifth embodiment of the present invention in the form of a portion of a vehicle; and

FIG. 12 is a side plan view of the fifth embodiment of FIG. 11.

### DETAILED DESCRIPTION OF THE PREFERRED EMBODIMENTS

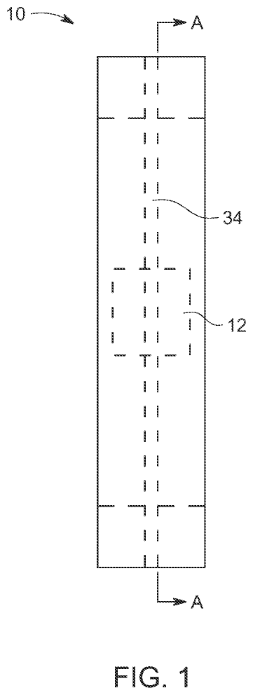

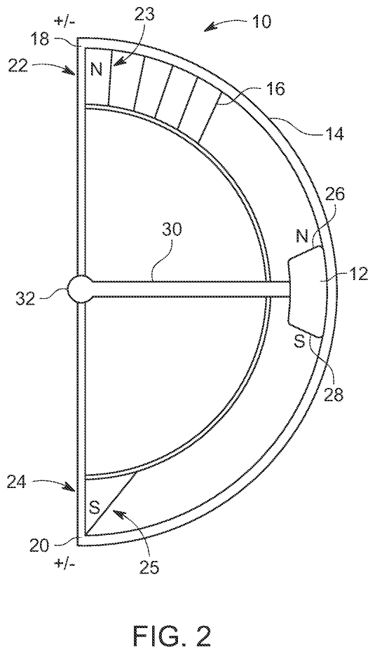

FIGS. 1 and 2 are figures of a first embodiment of the present invention of an energy capture device 10. A magnet 12 may traverse an arcuate path 14 preferably having coil 16 therein or thereabout so that as magnet 12 proceeds through the path relative to the coil 16, an electrical current/voltage is generated and passed relative to leads 18,20. First end 22 may have a magnet such as the North pole 23 illustrated. Second end 24 may have a magnet such as the South pole 25 illustrated. The magnet 12 may be attached to an arm 30 and rotate relative to a pivot 32, such as with the arm 30 passing through slot 34 in the path 14. Other embodiments may not have a slot 34. Shaking or otherwise oscillating the moving magnet 12 may generate electrical energy as would be understood by those of ordinary skill in the art.

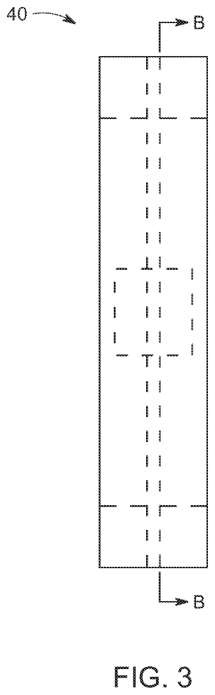

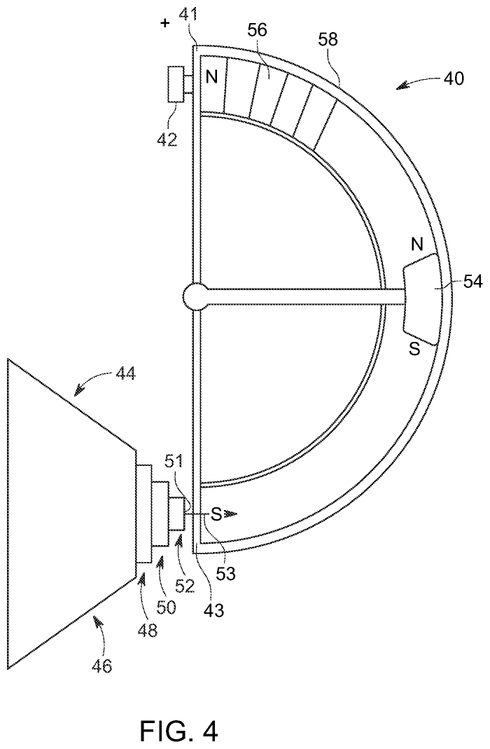

FIGS. 3 and 4 are figures of a second embodiment somewhat similar to the embodiment of FIGS. 1 and 2 of an energy capture device 40. With similar structure as the first embodiment, the difference being a separate first magnet stop 42 and a second magnet stop 44. The Second magnet stop 44 may take the form of a pyramid stack magnet which has a series of progressively smaller perimeter magnets 46,48,50,52 which is believed to act somewhat like a convex lens to focus or amplify the magnetic field of the second stop magnet 44. This embodiment may be able to act on gravity to downwardly direct the moving magnet 54 toward the second stop magnet 44. The magnetic repulsion forces may then at least assist in upwardly directing the moving magnet 54 towards the first stop magnet 42 which could have significantly less force than the second stop magnet to repel the moving magnet to begin the reversal of direction of the moving magnet 54 back toward the second stop magnet 44. Meanwhile coil 56 could capture electrical energy. Other motive forces could also move the moving magnet 54 within the arcuate path relative to the coil 56 to provide voltage/current at terminals 41,43 to assist in generating electrical energy as would be understood by those of ordinary skill in the art.

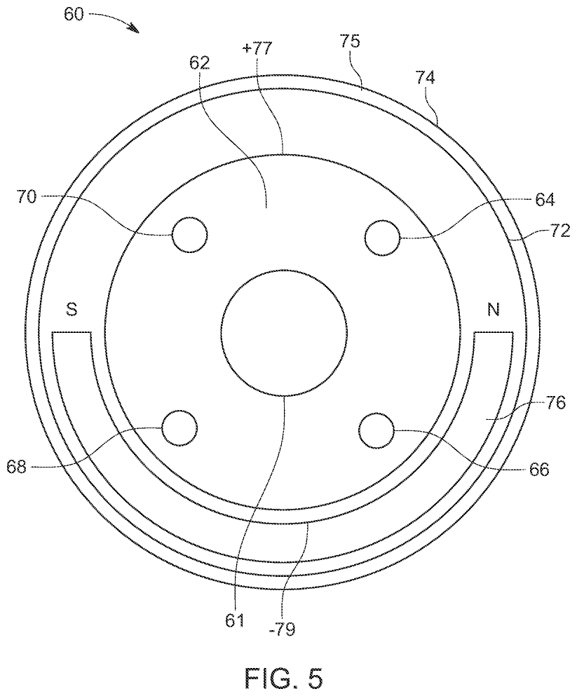

FIG. 5 shows an embodiment of an energy capture device 60 having a hub 62 with lug mounting locations 64,66,68.70. A copper tube 72 is shown connected to the hub 62 with a sheathing 74 which may house a coil internally thereto or otherwise. A magnet 76 may have a length of up to about half of the circumference of the copper tube 72 in an effort to maximize surface area of the magnet relative to the coil in the sheathing 74. As one of ordinary skill in the art will realize, as the hub rotates with whatever it is attached to (such as an axle), the tube will rotate while the magnet 76 is held in position by gravity thereby generating electricity through the coil 75 in the sheathing 74 to terminals 77,79 or other electrical conductors.

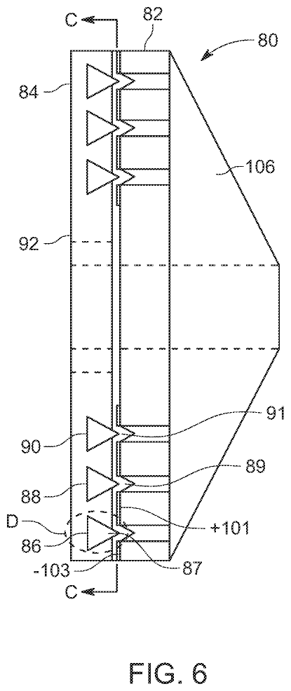

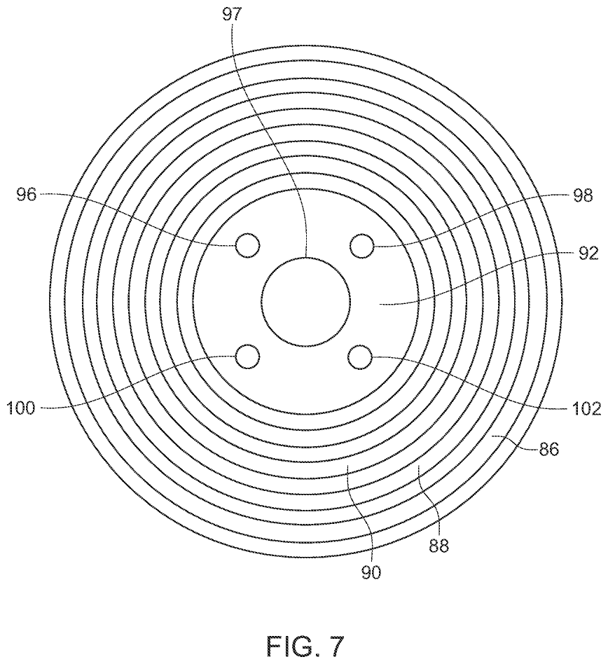

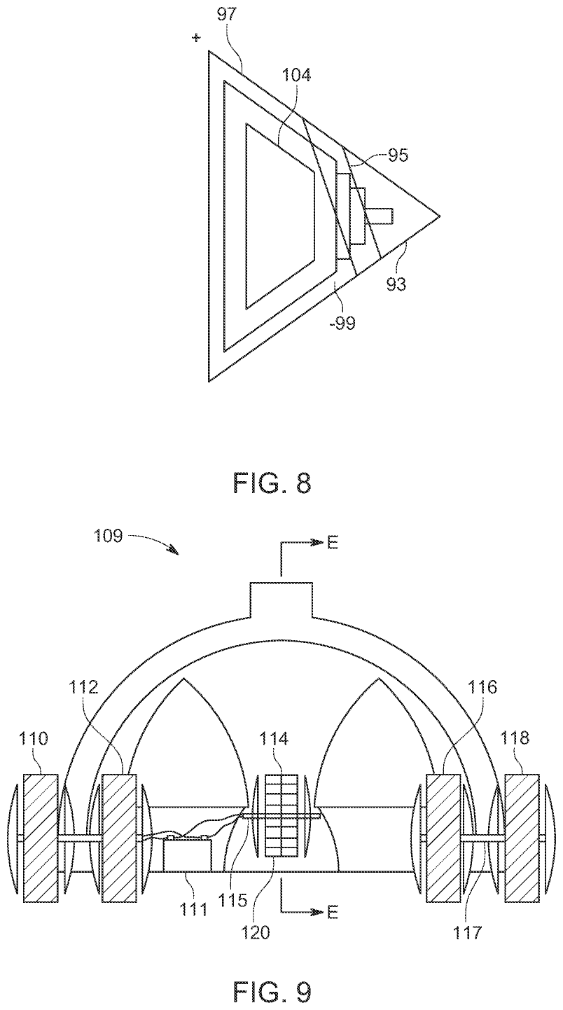

FIGS. 6-8 show a more advanced embodiment similar to FIG. 5 of an energy capture device 80 having a plurality of tubes, such as copper tubes, 86,88,90 mounted relative to a hub 92 which may be mounted to a shaft (not shown) but at bore 94 such as with bolts through mounting holes 96,98,100,102. An induction receiver 82 may be useful for receiving current from magnets 104 if they move relative to the induction receiver 82, or otherwise receive current from coils about each the tubes 86,88,90. Terminals 101,103 may be useful for some embodiments. Induction receiver 82 may have a disc like face 106 and/or other features. Coil terminals 97,99 on coil 95 may be useful for some embodiments.

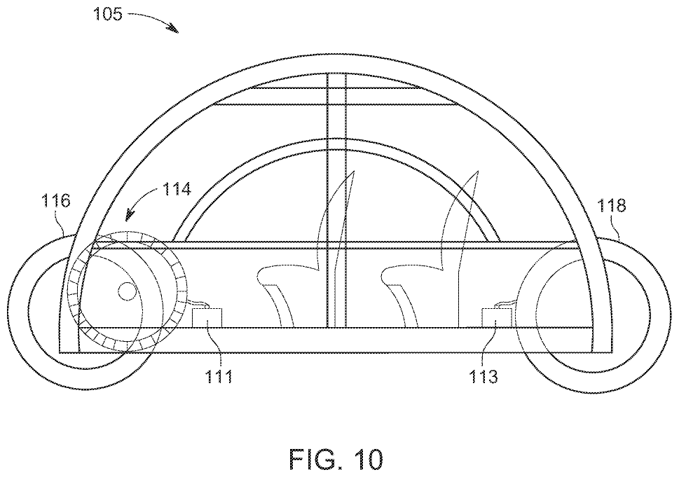

FIGS. 9 and 10 show a vehicle 109 having a plurality of energy capture devices 110,112,114,116,118. Four may be somewhat similar to those of FIGS. 6-8, or not, the other 114, being somewhat different in that it may be more of a wind-driven embodiment having vanes 120 onto which air may be directed to assist in rotating the energy capture device 114 to assist in generating electricity. The devices 110,112,116,118 may be more like regenerative braking devices to generate electricity and/or brake. Batteries 111,113 may collect and/or provide electricity to the devices 110,112,116,118.

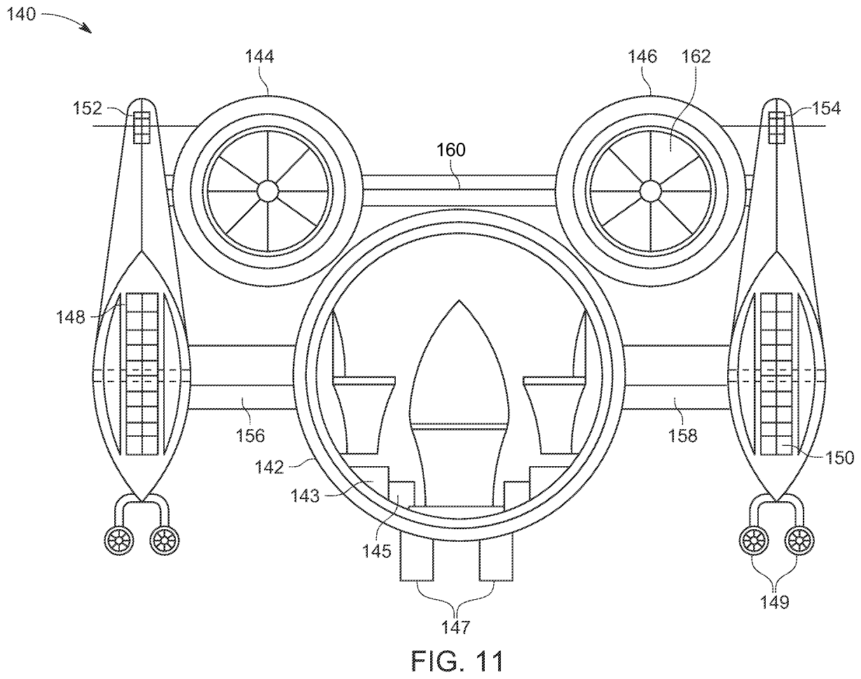

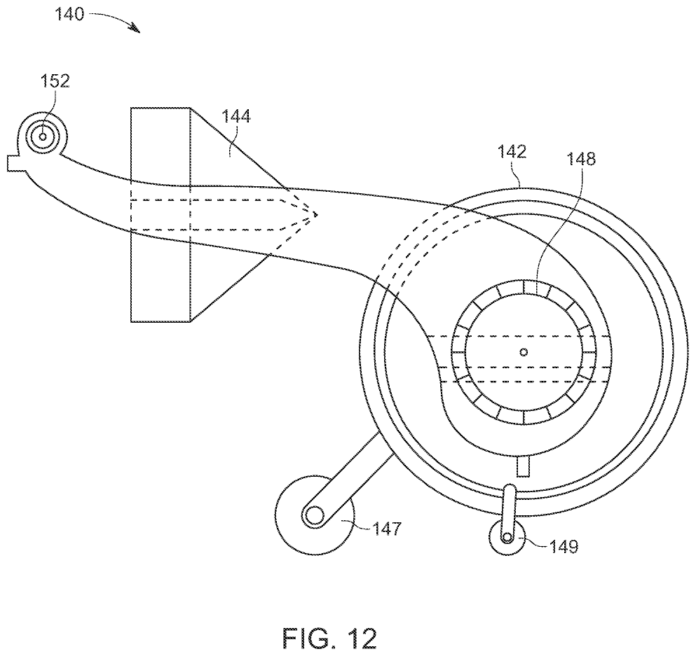

FIGS. 11 and 12 show a vehicle 140 which can have a center cut area 142 as well as a potential energy capture devices or thrusters 144,146 which may be similar constructed to one another as well as other energy capture devices and/or thrusters 148,150,152,154 wings 156,158,160 may assist in providing lifts. Although wheels are necessarily or could be provided to assist in take off and landing devices 144,146 may provide thrust to maintain the vehicle 140 in flights. Devices 148-154 may be sufficient as to assist in turning the vehicle 140 in flight as well. Also, it may be that some of the devices 144-150 may capture wind energy so as to assist in providing energy to drive thrust from devices 144,146.

Devices may be similar or dissimilar to the various devices of the embodiment shown in herein. One thing that may be different as it relates to devices 140,146 is the vanes 162 receive airflow parallel to the direction of rotation to the axis of rotation as opposed to perpendicular like the majority of the other embodiments shown herein. Batteries 143,145 may connect to the various devices 144-150 and wheels 147,149 may be useful for at least some embodiments.

Accordingly, various energy capture devices 10,40,60,80,110,112,114,116,118, 144,146,148,150,152,154 take on a variety of embodiments as shown throughout this application. In all these applications there is at least one magnet 12,22,24,54,42,44,76,104, etc. as shown in the various embodiments which is configured to direct a magnetic field relative to an arcuate path 14,58,72,86,88,90. There may be a coil 16,56,75 disposed about the arcuate path whether it be disposed about a copper coil, located within or about a sheathing 74 about the arcuate path, located along an aluminum tube coated with graphene, or other structure or somehow otherwise disposed relative to another conductor and/or arcuate path 14,58,72,86,88,90 of the respective capture device. At least one of the magnets systems utilized in all but one embodiment has a pyramid structure whereby the magnetic field is believed to be amplified in a somewhat similar manner as a convex lens amplifies light in a direction perpendicular to the smallest cross-section 51 of the magnet in direction of a pole 33 of the magnet 44 as illustrated in various embodiments.

Furthermore, relative motion of at least one of a magnet 54,76 relative to the coil 56,75, etc. generates electrical energy in the coil 56,75, etc. This can happen in the embodiments of FIGS. 1-4 through oscillation or the embodiments of FIG. 5-12 through rotation. In the embodiments of FIGS. 5-6 the arcuate path is a circle. Furthermore, many of the energy capture devices shown herein provide a plurality of coils 56,88,90 which are concentrically disposed relative to a central hub 92. The central hub 92 often has a bore 94 in the middle for receiving a shaft 115,117, etc. and either the rotation of the hub 92 creates relative motion in the coil relative to a magnet or the coil moves relative to the hub 92 to assist in generating energy by creating relative motion between the magnet and the coil.

Some embodiments may provide an induction receiver 106 which is preferably located beside the coil if not a plurality of coils 86,99,90. This induction receiver 106 may have grooves 87,89,91 which cooperate with pyramid shaped points 93 which extend from the coils towards the induction receiver 106 along the coils. A plurality of vanes 120,162 may also be provided in many embodiments as is shown in FIGS. 5-12 to assist in capturing wind energy. These vanes 120,162 often extend radially externally of the coils. Furthermore, the vanes 120 receive air flow which is directed in the direction which is perpendicular to the axis of rotation in one of the magnets and coils. The coils 86,88,90 can have a triangular shaped cross section as shown in some of the embodiments to thereby receive a pyramid structure of the magnets as is shown in some embodiments. Furthermore, in some embodiments, coils may be securely connected to the hub while in other embodiments the coils may rotate relative to the hub. For some embodiments, such FIGS. 1-4, magnets are constrained to travel within the arcuate path. An arm 30 connects to a pivot 32 to provide a magnet pivot such as in the embodiment of FIGS. 1-4. Some of the embodiments described above, such as FIGS. 3 and 4, permit the ability for a magnet 44 to provide a sufficient propulsion through magnetic repulsion upwardly direct the pivoting magnet 34 and then allow gravity to assist in bringing it back down so as to create a system to generate electricity from the relative motion of the pivoting magnet 54. Some of the embodiments show vehicles 109,140 which have one or more shafts which are received through a bore 61,94 in the hub 62,92 in various embodiments. These vehicles 109,140 may utilize the energy capture device as a portion of the regenerative braking system or the ability to convert wind and/or still other embodiments may utilize the energy capture device to convert relative wind energy into electricity. Some embodiments have vanes disposed on a periphery, radially externally relative to the coils while others, such as those of FIG. 11 of the energy capture devices 144,146 have the vanes configured to received airflow directed parallel to the axis rotation of the coil(s) and/or magnet.

Finally, the claims also discuss the ability to provide a magnet structure which is roughly at least a third of the length of the circumference of the coil if not half the length then provide additional service area to assist in generating electricity from the magnetic induction to the coil as due to the relative motion.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

1. An energy capture device comprising:
at least magnet configured to direct a magnetic field relative to an arcuate path:
a coil disposed about the arcuate path;
wherein at least one of the at least one magnet has a pyramid structure thereby amplifying the magnetic field from a direction perpendicular to a smallest cross section of the magnet in a direction of a pole of the magnet, and
whereby relative motion of at least one of the at least one magnet relative to the coil generates electrical energy in the coil.

2. The energy capture device of claim 1 wherein the arcuate path is a circle.

3. The energy capture device of claim 2 further comprising a plurality of coils concentrically disposed relative to a central hub.

4. The energy capture device of claim 3 wherein the central hub has a bore for receiving shaft, and one of (a) rotation of the hub creates relative motion of the coil relative to at least one of the at least one magnet, and (b) the arcuate path moves relative to at least a portion of the hub.

5. The energy capture device of claim 4 further comprising an induction receiver disposed beside the plurality of coils.

6. The energy capture device of claim 5 wherein the induction receiver has grooves which cooperate with pyramid shaped points extending from the coils toward the induction receiver along the coils.

7. The energy capture device of claim 4 further comprising a plurality of vanes, said vanes receiving relative wind to thereby spin the coils.

8. The energy capture device of claim 7 wherein the vanes are located radially externally of the coils.

9. The energy capture device of claim 8 wherein the vanes receive airflow in a direction perpendicularly to the axis of rotation of one of the coils and magnets.

10. The energy capture device of claim 2 wherein the coil has a triangular shaped cross section thereby receiving the pyramid structure.

11. The energy capture device of claim 3 wherein the coils are securely connected to the hub.

12. The energy capture device of claim 1 where at least one magnet is constrained to travel within the arcuate path and is connected by an arm to a pivot as a pivoting magnet.

13. The energy capture device of claim 13 wherein the arcuate path proceeds upwardly relative to the pyramid structure whereby magnetic repulsion pushes the pivoting magnet upwardly, and then gravity assists in downwardly directing the pivoting magnet back towards the pyramid structure.

14. The energy capture device of claim 1 wherein the coil is at least one of disposed about a copper coil, is located within a sheathing about the arcuate path, and is located along an aluminum tube coated with graphene.

15. The energy capture device of claim 2 further comprising a hub located radially inwardly of the coil; and a vehicle having a shaft, whereby the shaft proceeds through a bore in the hub.

16. The energy capture device of claim 15 wherein the energy capture device is a portion of a regenerative braking system.

17. The energy capture device of claim 16 wherein the energy capture device converts relative wind energy into electricity.

18. The energy capture device of claim 17 wherein a plurality of vanes are located radially externally to the coil.

19. The energy capture device of claim 2 wherein the at least one magnet has a length between one third and one half of the circumference of the coil.
